(19) United States
(12) Patent Application Publication
(10) Pub. No.: US 2021/0035121 A1
(43) Pub. Date: Feb. 4, 2021

(54) PROACTIVE DETERMINATION OF FRAUD THROUGH LINKED ACCOUNTS

(71) Applicant: Neu IP, LLC, Kansas City, MO (US)

(72) Inventor: Ryan A. Neuweg, Kansas City, MO (US)

(21) Appl. No.: 16/530,257

(22) Filed: Aug. 2, 2019

(51) Int. Cl. G06Q 30/00; G06Q 20/40

(52) U.S. Cl. CPC G06Q 30/0185; G06Q 20/4016

(57) ABSTRACT

A system and method of determining a likelihood of fraudulent activity by comparing information associated with a plurality of financial accounts and online databases is described herein. In some embodiments, information across multiple financial accounts is compared periodically and prior to activation of financial accounts to proactively determine fraudulent activity and fraudulent information. The information may be tracked and sent to authorities and an owner of the account may be notified of the fraudulent activity and requested to submit supplementary information.

### BACKGROUND

### 1. Field

Embodiments of the invention generally relate to determining that information is fraudulent. More specifically, embodiments relate to comparing information from multiple sources for verification of information.

### 2. Related Art

Some financial institutions track activity and provide alerts when out-of-the-ordinary activity occurs such as, for example, large withdrawals or spending at unrecognized locations. Alerts and requests may be sent to the owner of the account to verify that the user is aware of the activity. Typically, the activity is not designated as fraudulent and it is left up to the owner to recognize fraudulent activity on their account. By the time the owner of the account recognizes the activity, notifies the financial institution, and, in some cases, notifies the authorities, the fraudster may have used the information to make more purchases and open more fraudulent accounts using the account owner's information. In some cases, up to 99 credit card accounts may be opened under one identity. The current systems and methods for mitigating these fraudulent actions are inefficient and do little to deter fraudsters from opening fraudulent accounts and stealing identities. This costs people and companies tremendous time and money.

What is needed is an efficient system and method of proactively determining fraudulent information across a plurality of accounts that may be held at different financial institutions, tracking the accounts, and efficiently updating databases with known fraudulent information. Further, the information should be shared and actions on accounts should be taken in real time to prevent other accounts from being opened using the fraudulent information. Further still, the information may be tracked and sent to the authorities in real time such that an efficient investigation may be conducted in a timely manner. Systems that proactively determine fraudulent information associated with financial accounts and, in some cases, before financial accounts are activated, reduce the costs associated with identity theft, synthetic ID, and fraud. This greatly reduces the cost for the account owners and the financial institutions holding the accounts as well as the taxpayers funding the authorities responsible for tracking down the fraudsters.

### SUMMARY

Embodiments of the invention solve the above-mentioned problems by providing a system and method for tracking information across a plurality of databases and comparing the information to determine when fraudulent information is input into the system. An application may obtain information from the databases and compare the information with information known to be legitimate to look for inconsistencies. The application may also compare the information with information known to be fraudulent. A likelihood of fraud and a fraud score may be determined from the comparisons and rules may determine actions to be carried out based on the fraud score.

A first embodiment of the invention addresses the above-described need by providing for one or more non-transitory computer-readable media storing computer-executable instructions that, when executed by a processor, perform One or more non-transitory computer-readable media storing computer-executable instructions that, when executed by a processor, perform a method of identifying fraudulent activity through a comparison of linked information, the method comprising the steps of obtaining, for a financial account with a first financial institution, first information at least partially associated with an identity on the financial account; obtaining second information not associated with the identity from a database storing information associated with known fraudulent accounts, comparing the first information and the second information, determining that a first portion of the first information matches information associated with the identity and a second portion of the first information matches the second information associated with known fraudulent accounts not associated with the identity; and determining a fraud score based on the comparison of the first information and the second information.

A second embodiment of the invention addresses the above-described need by providing a method of identifying fraudulent activity through a comparison of linked information, the method comprising the steps of obtaining first information supplied by a user for opening a financial account at a first financial institution, accessing at least one database associated with a second financial institution comprising second information, comparing the first information and the second information, determining that at least a portion of the first information is consistent with the second information, and determining a fraud score based on the comparison of the first information and the second information.

A third embodiment of the invention provides for one or more non-transitory computer-readable media storing computer-executable instructions that, when executed by a processor, perform a method of identifying fraudulent activity through a comparison of linked information, the method comprising the steps of obtaining, for a financial account with a financial institution, first information at least partially associated with an identity on the financial account; obtaining second information not associated with the identity from a database storing information associated with known fraudulent accounts; comparing the first information and the second information; determining that a first portion of the first information matches information associated with the identity and a second portion of the first information matches the second information associated with known fraudulent accounts not associated with the identity; and determining a fraud score based on the comparison of the first information and the second information.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIG. 2 depicts an exemplary diagram for implementing the system;

FIG. 3 depicts an exemplary diagram for implementing the system associated with an online database;

FIG. 4 depicts an exemplary diagram for implementing the system associated with a second financial institution; and

FIG. 5 depicts an exemplary flow chart representing embodiments of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

At a high level, embodiments of the invention relate to systems and methods of comparing information to determine if at least a portion of the information is fraudulent. Information from a financial account or information provided by an account owner may be compared to information from other financial institutions, online databases, and databases comprising known fraudulent information. Further, the information provided by the account owner may be compared to known information associated with a data point of the information submitted to look for inconsistencies. A likelihood of the account or information provided being fraudulent may be determined. A fraud score may be calculated based on the likelihood of the account or information being fraudulent. Rules may dictate actions based on the fraud score such as sending notifications to financial institutions, account owners, and authorities and freezing or suspending associated accounts.

The systems and methods described herein may provide a proactive fraud detection system that reduces the cost of fraudulent activity to financial institutions and account owners. An efficient system that tracks activity and provides information to authorities to conduct a timely investigation may also be provided. These systems and methods reduce the cost to account owners, financial institutions, and the tax-paying public that fund the authorities that investigate the fraudulent activities.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made, without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

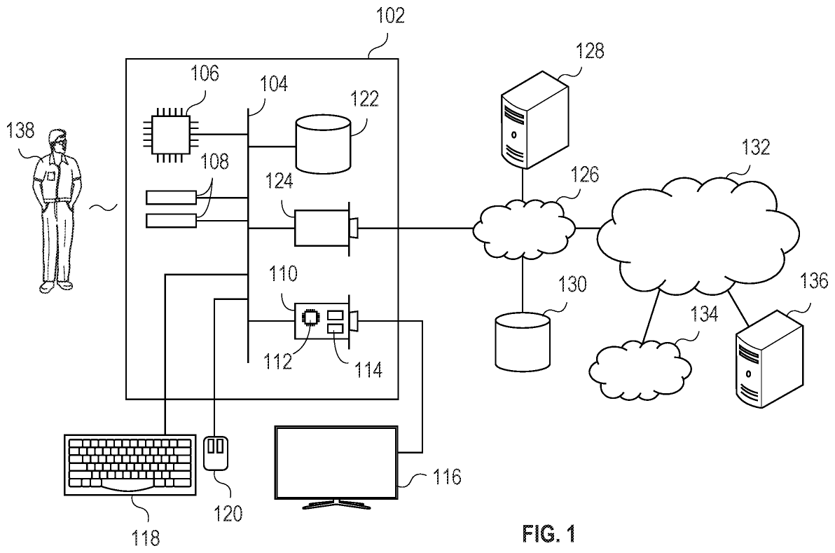

Turning first to FIG. 1, an exemplary hardware platform for certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also, attached to system bus 104 are one or more random-access memory (RAM) modules 108. Also, attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also, connected to system bus 104 is local storage 122, which may be any form of computer-readable media, and may be internally installed in computer 102 or externally and removeably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-usable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

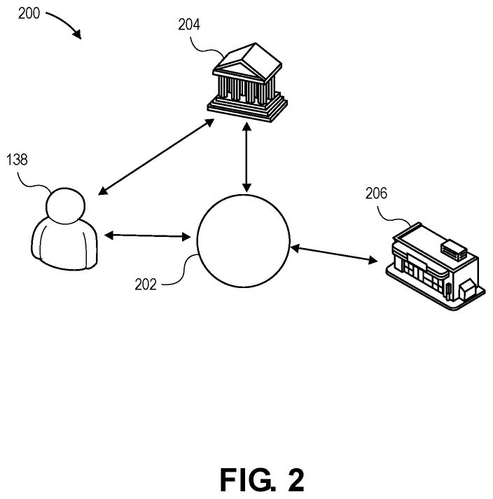

Turning now to FIG. 2 an exemplary block diagram showing certain elements of a system embodying the invention is depicted and generally referred to by reference numeral 200. As shown, an application 202 is connected to the user 138, a financial institution 204, and authorities 206. In some embodiments, the user 138 may interact directly with the application 202 and in some embodiments the user 138 may interact directly with the authorities 206. In some embodiments, the application 202 may run on the computer 102 and the computer 128 which, in some embodiments, may be a mobile device associated with the user 138 or may be accessed via the mobile device and run in a web-based environment from a web browser. The mobile device or computer running the web-based environment may store data such that it is not required for the mobile device or computer to have downloaded and stored large amounts of data for the application 202. The application 202 may access data associated with, for example, object databases, user profiles, information related to other users, financial information, third-party financial institutions, third-party vendors, social media sites, or any other online service, database, or website that is available online.

In some embodiments of the invention, the application 202 may access or store a profile of the user 138. In some embodiments, the user 138 may be an account holder with the financial institution 204. The user 138 may hold the account legitimately with all information associated with the user 138 being correct such that the account is non-fraudulent. In some embodiments described herein, the user 138 may be a fraudulent user that has entered information associated with a second individual as in an identity theft or synthetic identification (ID) situation. In some embodiments, the user 138 may activate an account with false information or partially false information or may be accessing the account of a legitimate user. In some embodiments, the user 138 submits information partially associated with the user 138 and partially associated with a second person or persons. The user 138 may be any person or persons that accesses the application 202 and the financial account through the financial institution 204 through any accessible device. In some embodiments, the user 138 may be another financial institution, company, corporation, or other entity with finances that may be compromised by a fraudulent user.

In some embodiments, the application 202 may be downloaded on a mobile device which, in some embodiments, is computer 102 or accessed via the Internet as in a cloud-based application for account tracking and alerts. In some embodiments, notifications and alerts may be sent to the user 138 directly through the financial institution 204 holding the account and the application 202 may be utilized only by the financial institution 204.

The user 138, in the case of a new user, may be prompted to set up a profile or account for use with the application 202 through the financial institution 204 or directly through the application 202. The user 138 may input such exemplary items (or data points) as, for example, age, race, nationality, social security number (SSN), a history of addresses, Date of Birth DOB, telephone number, and any other information associated with the user 138 that may be used to compare to online information to identify fraudulent activity associated with the information submitted by the user 138. For example, the user 138 may submit SSN and a history of addresses. The application 202 may access a database comprising information from accounts held at the financial institution 204 and discover that the SSN associated with the user 138 is on the database several times. Each of the instances of the SSN is associated with an address corresponding to an address provided by the user 138 except one. The one address that is not associated with the user 138 is automatically sent to the user 138 with a question (i.e. “Do you recognize this address”). The user 138 indicates no, and the application flags the account associated with the unrecognized address as fraudulent. Further, a likelihood of the account being fraudulent may be calculated based on the unrecognized address and the verification by the user 138 that the address is not a previous address.

Continuing with the exemplary embodiment depicted in FIG. 2, the user 138 may access a financial account held by the financial institution 204 via an electronic device as described above. The application 202 may be in communication with the financial institution 204 and have access to obtain information from the account of the user 138. The information that is accessed by the application 202 may be restricted to information either approved or submitted by the user 138 or the financial institution 204. The application 202 may also be in direct communication with the authorities 206 which may be a regulatory commission such as the police or a fraud department of the local, national, international, state, or federal authorities.

In an exemplary embodiment, the user 138 may notice a charge on the account that does not look familiar and, upon further review, the user 138 may flag a charge on the account as fraudulent. The financial institution 204 may request that the user 138 contact the authorities 206. The application 204 may track the activity on the account and store the information with an indication of the suspected fraudulent transaction. In some embodiments, the application 202 may search the account for instances of similar transactions by location, amount, or any other attribute associated with the suspected fraudulent transaction to determine if any other transactions may be fraudulent. If any other suspected transactions are flagged, the request to verify the transaction may be sent to the user 138. Further, the application may search other accounts associated with the financial institution 204 using the attributes to determine if similar fraudulent information is associated with other accounts.

In the event of suspected fraudulent activity, the account of the user 138 may automatically be frozen by the application 202. The user 138 may be notified of the fraudulent activity and the account freeze by the financial institution 204 or through the application 202 or both. The notifications or any other feature may be customized by the user 138 at the financial institution 204 or by any online website or any downloadable or cloud-based application associated with the financial account or by direct access to the application 202.

In some embodiments, the fraudulent activity is tracked, and a history of fraudulent activity is sent to the authorities 206. In some embodiments, the user 138 may request that that the authorities 206 open an investigation and provide the authorities 206 access to a tracked history of activity on the account.

In some embodiments, an investigation of the authorities 206 may be time constrained to a set number of days, weeks, months, or years. For example, in California, any documents that may be used as evidence may only be submitted within 30 days of the request to investigate. Time constraints may be dependent on federal and local laws and, as such, a timely response is important. The application 202 may track and organize the account activity which may provide the user 138 and financial institution 204 the ability to submit the necessary information indicative of fraudulent activity in a timely manner consistent with the applicable laws. This reduces the burden on the user 138 and the financial institution 204 saving time and money for the financial institution 204 and the user 138. Further, this reduces the workload and the time and cost for the authorities 206 thus reducing the cost to the tax-paying community.

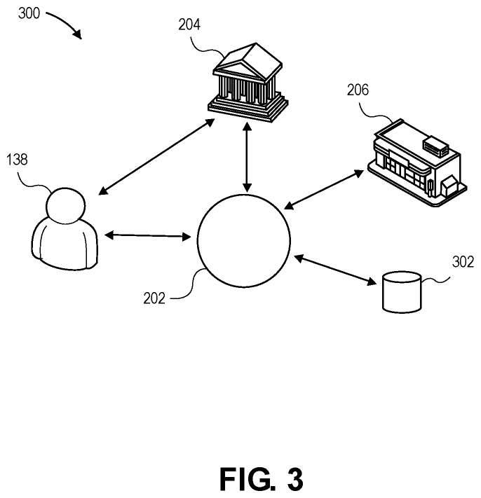

In an embodiment depicted in FIG. 3 by the exemplary flow diagram 300, the application 202 may access an online database 302 for comparing suspected fraudulent information with known fraudulent information. Further, the application 202 may compare information submitted by the user 138 with information online through the database 302 to check for inconsistencies in the data. Further still, the account information may be compared to online information by the application 202 to check for any other information that may be found online to be associated with a suspected fraudster identity.

The application 202 may track account transactions and flag any information that may be suspected to be fraudulent as described above. In some embodiments, the application 202 may compare information indicative of a new account with information stored in local database and the online database 302 to determine a likelihood of fraudulent information. For example, the user 138 may attempt to open a new financial account via the financial institution 204. The user 138 may supply information such as SSN, a Date of Birth (DOB), a home address, a driver's license number, and any other information that may be requested by the financial institution 204 and the application 202.

In some embodiments, the application 202 may access the online database 302 which may be, for example, secure databases containing known fraudulent information, social media sites, the Department of Motor Vehicle, or any other database that may comprise the information associated with the identity of the user 138. Further, the application 202 may access a secure database that may be held by the regulating authorities 206 that may be an international, a federal, or a local financial regulatory commission. For example, the user 138 may submit information for opening an account with the financial institution 204. The financial institution 204 may transmit the information to the application 202 or the information may be automatically reviewed by the application 202. In some embodiments, the information is submitted directly through the application 202 before being released to the financial institution 204. The application 202 may automatically compare the information received from user 138 with information indicative of fraudulent activity stored on a database associated with the application 202. The comparison may reveal that at least a portion of the information matches information used in fraudulent activity. The account may be frozen until the matter is cleared. The database of the application 202 may reveal that the address or SSN that was provided may be registered to a different person, Frank Wilson. Frank Wilson may be contacted to verify the address and the information. Frank Wilson may indicate that he has moved, and the name is different because he is opening an account to which his daughter will have access. Once the information is cleared and updated, the account may then be opened.

In some embodiments, the application 202 uses data points from the information to look for inconsistencies within the application storage database or online. For example, the user 138 may provide information as described above. The application 202 may scan online databases searching for, for example, the address. The address may be found but associated with a different name, SSN, DOB, and so on. The application 202 may then automatically scan recent address changes at a database associated with, for example, the Yellow Pages, or the Post Office, and determine that the user 138 recently placed a change of address form and the different identity associated with the address may be outdated. A likelihood of fraud may be calculated, and a fraud score associated with the account. The account may not be opened until this discrepancy is cleared. Based on the fraud score and the discrepancy the application may send a request to the user 138 “When did you move to this address?” The user 138 may submit a response and the response and the change of address form are compared for consistency by the application 202. The dates are consistent, and the account is opened for the user 138 based on a detection of no fraud.

In some embodiments, the application 202 may compare information on any online site associated with the user 138 or an online site associated with the information provided for opening the new account. For example, the application 202 may access social media databases associated with the user 138 and determine that the address and the name on the financial account are not consistent with the name and address on the social media site. The name on the financial account is Frank Wilson but there is no Frank Wilson on the social media site with the identified address. Any data points, or information, may be used to search and match on any of the databases described herein. For example, the address and the name may then be searched on a social media site and it is determined that the address matches a different name, for example, John Smith. The application may search a database associated with the financial institution 204 and determine that the SSN is listed under an account assigned to Frank Wilson. The account is then flagged as potentially fraudulent and Frank Wilson is informed that his information is being used to open an account. When Frank Wilson informs the financial institution 204 that he is not attempting to open an account, the account is locked. The information obtained by the application 202 may be sent to the authorities 206 along with the possible identity of the fraudster John Smith. Further, the information is then stored in a database associated with the application 202 for future comparisons of information.

In some embodiments, the data points may be used to determine a likelihood of fraudulent activity. The data points may be any information associated with the user 138 or the user account. The data points may be information received from the user 138 or may be information determined to be associated with the user 138 by the application 202. As in the example described above, the name John Smith was the fraudster as was determined from the address provided by the user 138. The name John Smith may then be used as a data point to collect more information via the database 302, the financial institution 204, and the authorities 206 and determine a likelihood that John Smith is committing fraudulent activity. For example, information associated with John Smith such as, for example, the address used by John Smith may be used to search any of the databases as described above. The application 202 may find that the address matches 10 instances of different names and SSNs. These accounts are given a high fraud score and subsequently locked based on rules associated with the high fraud score. In some embodiments, as described below, the database 302 is associated with other financial institutions and accounts associated with the other financial institutions may also be scanned and frozen by the application 202.

In some embodiments, a likelihood of fraudulent activity may be determined by the type of data point. The likelihood of fraudulent activity based on type of data point may be used to determine a fraud score. For example, the type of data point may be the type of information associated with the user 138. The user's name may be the data point type and the name may be the same as a name used in known fraudulent activity. The user's name may be John Smith that is a very common name such that the likelihood of this being fraudulent may be low. However, the user's name may be more specific such as Malcolm J. Cunningham and may be known to be linked to fraudulent activity. This may result in a higher likelihood that at least some information is fraudulent because the name is much less common.

In some embodiments, different likelihoods may be provided to different types of data points. For example, the use of a fraudulent address may provide a higher likelihood than a name. The fraudulent activity may be tracked over time and the likelihood of fraudulent activity based on type may be determined from a statistical analysis of the history of fraudulent activity associated with the type of data points analyzed.

In some embodiments, a likelihood of fraudulent activity may be determined by the number of data points. The likelihood of fraudulent activity based on number of data points may be used to determine a fraud score. For example, a name may be found that matches a known fraudster and a low likelihood of fraudulent activity assigned. However, an SSN and an address along with the name associated with a known fraudster may be obtained by the application 202 and a relatively high likelihood of fraudulent activity assigned. Number of matches in a particular set of data points may be analyzed. The user 138 may submit a set of data points, for example, name, SSN, DOB, address, or any other information that may be used to open a financial account. In some embodiments, information associated with the user 138 may be stolen and used to purchase items in which the data points are location, time, purchased items, address for delivery of purchased items, and the like. The address for delivery of the purchased items may be flagged from a recent fraudulent transaction and the transaction to purchase the items may be blocked and the account frozen in real time.

In some embodiments, fraudulent activity may be tracked over time and stored in the application database and the likelihood of fraudulent activity based on type and number may be determined from a statistical analysis of the history of fraudulent activity associated with the number of data points analyzed. In some embodiments, the likelihood determined by type of data points and the likelihood determined by number of data points may be combined to determine an overall likelihood of fraudulent activity. The overall likelihood of fraudulent activity may be presented as a total fraud score. Each likelihood may be determined then combined then a total fraud score may be determined or in some embodiments, a score may be determined for each type and number of fraudulent activity and combined to determine a total fraud score.

In some embodiments, the application 202 may suggest action or take action based on the determined likelihood or fraud score indicative of fraudulent activity. Rules may be in place that instruct the application 202 or the financial institution 204 to freeze an account, notify the financial institution 204, notify the user 138, notify the authorities 206, update any database associated with the fraudulent activity, and take any other action that may be necessary in mitigating fraudulent activity. For example, a likelihood of 0.2 that a data point is fraudulent mat be determined. A fraud score of 20 is then associated with the account and it is noted that the data point is the address. The fraud score of 20 may be based on one data point and the data point being address. One data point and the data point being name may result in a lower fraud score such as, five, for example. A rule associated with the type of account relates a fraud score to different rules. For example, if a fraud score is equal to or greater than 20 then freeze the account and send an alert to a known person associated with the account for verification of the information associated with the account. If the fraud score is equal to or over 80 shut down the account and alert the authorities 206 immediately. The application 202 may implement any statistical modeling, artificial intelligence, neural networks, and machine learning algorithms to calculate and update the likelihood models for determining the likelihood and fraud scores indicative of fraudulent activity.

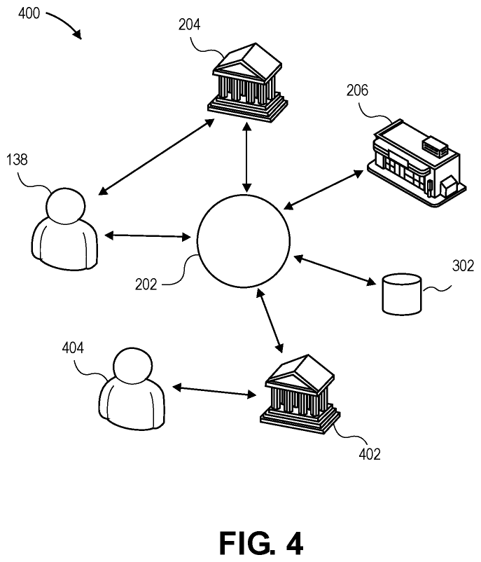

FIG. 4 depicts an exemplary flow diagram 400 depicting the operation of an embodiment of the application 202 associated with financial institution 202, the user 138, the authorities 206, the online database 302, and a bank 402 that may be associated with an account owner 404. In some embodiments, the bank 402 is any financial institution and may be financial institution 204 and the account owner 404 is any user and may be user 138. In some embodiments, bank 402 is representative of at least one, or a plurality, of financial institutions. The account owner 404 may be a fraudster or may be representative of any person or persons associated with any of the at least one, or plurality, of financial institutions.

In some embodiments, the application 202 takes information from a plurality of financial institutions and cross references the information to build a database and compare information to determine a likelihood of fraud and fraud scores. The application 202 may pool the information from the financial institutions to proactively identify fraudulent accounts or suspected fraudulent activity. All accounts and online information may be tracked and pooled such that if fraudulent information is detected in one account, other associated accounts can be identified and the user 138, or correct owner of the information, if any, can be notified.

Accounts can be evaluated at any time including when transactions occur and when transactions at other financial institutions occur. For example, the user 138 may own an account at the financial institution 204 and the application 202 may detect possibly fraudulent activity based on the information associated with the account. The application 202 may detect that cash was withdrawn from the account at a location that is not normally frequented by the user 138. An alert may be sent to the user 138 indicating the cash withdrawal along with a request to confirm the withdrawal. The user 138 may indicate that the withdrawal was not made by the user 138 and the account is flagged as compromised. The alert may be sent before or after the withdrawal is authorized by the financial institution 204. In some embodiments, the application 202 may scan all transactions and determine the inordinate location prior to dispensing the cash and send the alert in real time.

Once the withdrawal is determined to be fraudulent, the application 202 may store information associated with the account and the fraudulent transaction. The application may associate the Automatic Teller Machine (ATM) number and location with fraudulent activity and scan stored information to determine if there have been other fraudulent activities associated with the ATM in question. A list of suspected fraudulent transactions associated with the ATM may be created and stored and sent to the authorities 206. In some embodiments, the application may create a list of known fraudsters in the area of the ATM. The application may automatically notify the authorities 206 of the fraudulent activity, the date and time, the ATM, and any information associated with the possible fraudster such as the known fraudsters in the area of the ATM. In some embodiments, the application can access the date and time and retrieve an image from the ATM camera storage to store with the transaction information. In some embodiments, the application 202 may access any peripheral device including cameras, sensors, GPS data, social media accounts, browser histories, or any other devices on the computers, mobile devices, or ATM for retrieving data associated with suspected fraudulent activities.

In another exemplary embodiment, an account owner 404 may attempt to open an account at the bank 402. The account owner 404 may provide information to the bank 402 with a name and an SSN of a user 138. The application 202 may scan other financial institutions and determine that the SSN and name are associated with user 138 but with a different phone number and address are associated with the user 138 at financial institution 204. The application 202 may obtain the information provided by the account owner 404 for verification. The application 202 may compare the information from the account owner 404 with information from other financial institutions as well as the other online database 302 described above.

In some embodiments, the application 202 stores a database of all information described above and updates the information periodically to maintain the most recent information. The application 202 may proactively determine fraudulent information in this way. Continuing with the above described example associated with FIG. 4, the application 202 may determine that the phone number and the address are flagged for being associated with a different SSN on a different account that has been determined to be that of user 138. The application 202 may determine that there is a high likelihood that the information provided by the account owner 404 is fraudulent and recommend that the bank 402 not open the account. In some embodiments, the user 138 and authorities 206 are contacted and information associated with the account, the user 138, the phone number and the address, as well as any other account information associated with the phone number and the address may be sent to the authorities 206.

The above described exemplary embodiment presents a scenario where the application proactively determines fraudulent activity. Typical current systems are reactive only and determine if activity is fraudulent only after the information has been identified. The current system determines fraudulent activity, in some embodiments, before money has transferred and, in some cases, before accounts are opened. In some cases, up to 99 different accounts may be opened by a single fraudster. The application 202 may detect these associated accounts and may save money for both the customers and the financial institutions as well as provide a system that may detect associated information of fraudsters and aid in capturing the fraudster in a short time.

Continuing with the exemplary embodiment depicted in FIG. 4, the application 202 may compare information from the stored application database with accounts at the financial institution 204, the bank 402, the online database 302, the authorities 206, and any other account or database that may be associated with the application 202. The application 202 may search any accounts that contain possible fraudulent information and determine a fraud score for the accounts as described above. This method may detect accounts containing information that may newly have been determined to be fraudulent or accounts that are not actively being used such as, for example, sleeper accounts.

In another exemplary embodiment, a fraudster may attempt to change account settings to gain access to the account. For example, a fraudster may gain access to personal information of user 138. The fraudster may determine from, for example, a social media account personal information such as a phone number, relative's names, pet's names, DOB, and any other information that may be useful to the fraudster. The fraudster may call or access the financial institution 204 online acting as the user 138 and provide information to change the account settings. For example, the fraudster may call and provide SSN information and email information and ask to change the online username and password for the account. The financial institution 204 representative may ask a series of questions such as “What is your father's middle name?” or “What is the name of your pet?” The fraudster may answer the questions and request a phone number change as well. The new information may be sent to the application 202 during the phone call and the application 202 may return that there is a likelihood that the change is fraudulent based on the phone number provided. The financial institution 202 representative may be placed in contact with the user 138 via the old phone number associated with the account and determine that the information associated with the user 138 is compromised and the caller is trying to access the account fraudulently. The authorities 206 may be notified and provided all information recorded by the application 202 including the phone conversation and any information associated with the phone call such as, for example, location of the caller and service provider.

As described above, in some embodiments, the account may be fraudulent and/or the user 138 may be a fraudster attempting to access or open a legitimate account under a legitimate identity. In any case a portion of information that is provided must link to the fraudster. All information obtained by the financial institution 204 through payment, social media, other financial institutions, and information provided by the fraudster, as well as any information associated with the account and a purchase or transaction, may be stored in a database and cross referenced with any information from financial institutions to determine possible fraudulent information. The fraudulent information may be given a fraud score, probability, or likelihood of being fraudulent. In some embodiments, the identity of the fraudster may be determined with a certain likelihood, probability, and an identity score associated with the identity of the fraudster.

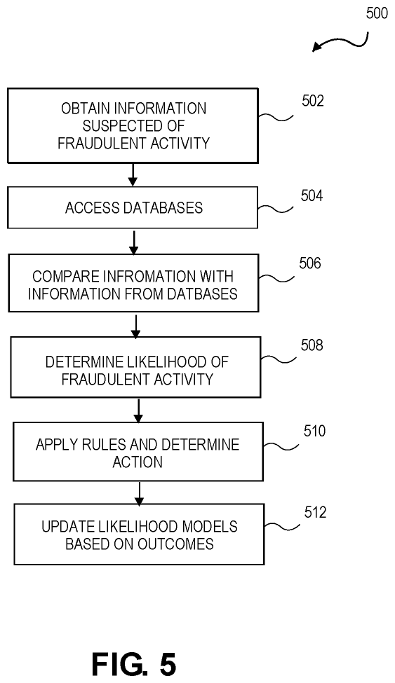

FIG. 5 depicts a flow diagram 500 representing exemplary methods of identifying fraudulent information. At step 502, the application 202 may receive information indicative of fraudulent activity as described in embodiments above. The application 202 may access the accounts directly as the application 202 may be stored and run at the financial institution 204, on a mobile device, a computer, or may be connected wirelessly and run at a remote location. In some embodiments, the application 202 may be accessed through or be a cloud-based application.

At step 504, the application 202 may access various databases to compare the information as described in embodiments above. In some embodiments, the application 202 may receive or obtain information indicative of the user 138 and the account of the user 138 from the account of the user 138, from the user 138, or from the financial institution 204. The information may be obtained by the entity supplying the information to the application 202 or the application 202 may have access to the financial database and the financial accounts of users associated with the databases. Further, information may be obtained using the information from the accounts and the information associated with the users. Information from the accounts may be used to find associated information on online databases such as, for example, social media, federal databases, and any other databases that may contain information that may be compared for consistency and may aid in determining fraudulent information and the identity and location of fraudsters. All information obtained by the application may be stored and associated on the application database which in some embodiments is local storage 122.

At step 506, the application 202 may compare the information obtained from the financial account with the information from other financial accounts and databases as described in embodiments above. The application 202 may compare newly acquired information with known information from fraudsters and information associated with other financial accounts. The comparison may detect fraudulent information or partially fraudulent information associated with synthetic identification. Further, information provided to open an account may be analyzed to determine if the information contains inconsistencies such that the account should not be allowed. Further still, the application 202 may compare and update information at intermediate times and periodically to detect sleeper accounts and compare newly acquired information. This may aid in detecting any new accounts and use updated information such that multiple accounts may not be opened by a single fraudster.

At step 508, the application 202 may determine a likelihood and provide a sensitivity score or a score indicative of the probability that the information is fraudulent as described in embodiments above. In some embodiments, the likelihood of information being fraudulent, and the amount of information suspected of being fraudulent, is determined. A fraud score based on the likelihood of the information being fraudulent may be determined and be sent to the user 138 and the financial institution 204 holding the account or the financial institution 204 may request a fraud score for a new account. In some embodiments, likelihood and scores are determined from a periodic comparison of information across all accounts associated with a particular user 138, data points associated with the user 138, and online databases.

At step 510, the application 202 may apply rules based on the indication of fraudulent information as described in embodiments above. Rules may dictate actions based on the fraud scores. In some embodiments, the application 202 may send recommendations to or automatically open or freeze accounts based on the determined fraud scores from information associated with the financial accounts. Based on the fraud score, the application 202 may send notifications and alerts such as instant messages, emails, social media posts, or the like to the user, financial institution 204, and the authorities 206 as well as other financial institutions that may be associated with the fraudulent activity or the found-to-be fraudulent information. In some embodiments, a representative associated with the application 202 may be prompted to call the user 138, financial institution 204, the other financial institutions, and the authorities 206 based on the fraud score.

At step 512, the application 202 may update the rules and the likelihood measures for future use as described in embodiments above. In some embodiments, the application 202 may track the results of the fraud scores such that, for example, when a fraudster is apprehended using certain information the application updates the information. The likelihood of fraudulent activity associated with the information may change based on certain factors. When information is determined to be fraudulent the likelihood associated with any account utilizing the fraudulent information or data points associated with the account may go up and the entity associated with the information may be informed or the suspected fraudster identity may be relayed to the authorities 206 based on the rules associated with the fraud score. Further, when new fraudulent information may be received from, for example, bank 402, the application 202 may update the likelihood models and check the information associated with accounts from bank 402 to determine if accounts from financial institution 204 include the fraudulent information. The fraud scores for the accounts that include the fraudulent information may be increased based on the fraudulent information and the rules applied to perform the designated action based on the fraud scores.

It should be noted that the flow chart may be in any order as allowed without losing functionality for different embodiments of the invention. Some steps may be combined when it may not be necessary for the steps to be separate. Some steps may be omitted while still allowing embodiments of the invention.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed, and substitutions made herein, without departing from the scope of the invention as recited in the claims.

Having thus described various embodiments of the invention, what is claimed as new and desired to be protected by Letters Patent includes the following:

1. One or more non-transitory computer-readable media storing computer-executable instructions that, when executed by a processor, perform a method of identifying fraudulent activity through a comparison of linked information, the method comprising the steps of:
obtaining, for a financial account with a first financial institution, first information at least partially associated with an identity on the financial account;
obtaining second information not associated with the identity from a database storing information associated with known fraudulent accounts;
comparing the first information and the second information;
determining that a first portion of the first information matches information associated with the identity and a second portion of the first information matches the second information associated with known fraudulent accounts not associated with the identity; and
determining a fraud score based on the comparison of the first information and the second information.

2. The method of claim 1, wherein the fraud score is determined based on the presence of the second portion of the first information in the at least one database storing second information associated with known fraudulent accounts not associated with the identity.

3. The method of claim 1, wherein the financial institution is a the first financial institution and the database is associated with a second financial institution distinct from the first financial institution.

4. The method of claim 1, wherein the database is aggregated from a plurality of financial institutions.

5. The method of claim 1, wherein the first portion of the first information includes at least one of a name, a social security number, and a date of birth associated with the identity.

6. The method of claim 5, wherein the second portion of the first information includes at least one of an address and a telephone number associated with known fraudulent accounts not associated with the identity.

7. The method of claim 6, wherein the fraud score is determined based at least in part on a number of data points of the first information that correspond to the identity.

8. The method of claim 6, wherein the fraud score is determined based at least in part on a type of data points of the first information that corresponds to the identity.

9. The method of claim 7, wherein first financial account is an account currently being applied for by an applicant.

10. A method of identifying fraudulent activity through a comparison of linked information, the method comprising the steps of:
obtaining first information supplied by a user for opening a financial account at a first financial institution;
accessing at least one database associated with a second financial institution comprising second information;
comparing the first information and the second information;
determining that at least a portion of the first information is consistent with the second information; and
determining a fraud score based on the comparison of the first information and the second information.

11. The method of claim 10, further comprising the step of notifying the user when it is determined that the second information is not consistent with at least a portion of the first information.

12. The method of claim 10 further comprising the steps of:
requesting additional information from the user;
determining a first data point from the first information that is inconsistent with a second data point associated with the second information;
determining at least one additional account associated with the first data point; and
notifying the user that the first information is compromised.

13. The method of claim 10, further comprising the step of notifying a second user associated with the second information that the second information is associated with the first information.

14. The method of claim 10, further comprising the step of notifying authorities based on a rule associated with the fraud score.

15. The method of claim 10, further comprising the step of notifying the financial institution of the fraud score and recommending that the financial account not be opened.

16. One or more non-transitory computer-readable media storing computer-executable instructions that, when executed by a processor, perform a method of identifying fraudulent activity through a comparison of linked information, the method comprising the steps of:
obtaining, for a financial account with a financial institution, first information at least partially associated with an identity on the financial account;
obtaining second information not associated with the identity from a database storing information associated with known fraudulent accounts;
comparing the first information and the second information;
determining that a first portion of the first information matches information associated with the identity and a second portion of the first information matches the second information associated with known fraudulent accounts not associated with the identity; and
determining a fraud score based on the comparison of the first information and the second information.

17. The method of claim 16, wherein the financial institution is a first financial institution and the database is associated with a second financial institution distinct from the first financial institution.

18. The method of claim 16, further comprising the step of searching for at least one additional financial account that matches the second portion of the first information.

19. The method of claim 18, further comprising the step of determining a second fraud score for the at least one additional account.

20. The method of claim 16, wherein the first information is obtained when an applicant submits the first information to open the financial account.
